(19) United States
(12) Patent Application Publication
(10) Pub. No.: US 2007/0283117 A1
(43) Pub. Date: Dec. 6, 2007

(54) Unmanaged memory accessor

(75) Inventors: Ramasamy Krishnaswamy, Redmond, WA (US); Marek Olszewski, Toronto (CA); Anthony J. Moore, Seattle, WA (US); Brian Grunkemeyer, Redmond, WA (US); Kim Hamilton, Bellevue, WA (US)

Correspondence Address: THOMAS HOLM LAWSON, 1004 PALOS VERDES CT., ROSEVILLE, CA, 95661, US

(73) Assignee: Microsoft Corporation, Redmond, WA (US)

(21) Appl. No.: 11/820,852

(22) Filed: Jun. 20, 2007

Related U.S. Application Data
(63) Continuation-in-part of application No. 11/422,297, filed on Jun. 5, 2006.

(51) Int. Cl. G06F 12/00

(52) U.S. Cl. 711/163

(57) ABSTRACT

Various technologies and techniques are disclosed for allowing accesses to unmanaged memory. An unmanaged memory application programming interface is provided for allowing accesses to unmanaged memory. The application programming interface has a constructor, dispose method, read method, and write method. The constructor allows an instance of an unmanaged memory object to be created. The dispose method allows the instance of the unmanaged object to be controlled. The read method accepts a pointer as a parameter and yields a structure containing one or more values that were read. The write method performs a write operation to a specified location. The application programming interface enables random access to previously allocated unmanaged memory in a type-safe and memory-safe way, with the random access being allowed to any location within the unmanaged memory.

### CROSS-REFERENCE TO RELATED APPLICATIONS

This is a continuation-in-part application of application Ser. No. 11/422,297, filed Jun. 5, 2006, the specification of which is incorporated by reference herein in its entirety.

### BACKGROUND

When a computer program accesses a resource, whether it be memory or a handle to an operating system object (such as a file, network socket, pipe, window, or console), the lifetime management can become very tricky. In multithreaded applications, it is possible to free resources while another thread is still using a resource. In systems that allow code to run with differing trust levels, this could become a security hole. Some solutions exist for handles and buffers, but they do not help with controlling access to memory.

Let's review why operating systems use handles to protect resources, and how lifetime is tracked. Intercession by an access supervisor is important for several reasons. For instance, when a first software module deletes a resource, other software modules that maintain direct pointers to the resource are unable to access or use the resource because their pointers no longer point to a valid resource. One solution to this problem involves having an access supervisor intervene when a software module requires access to a particular resource. Such intervention ensures that a particular resource still exists before the software module is granted access to the particular resource. Typically, such intervention is accomplished by the access supervisor issuing a handle to each software module for a particular resource instead of allowing each software module a direct pointer to that particular resource.

Handle administration systems are typically characterized by having handles that can assume either an allocated state or an unallocated state. When a handle is in the allocated state, the access supervisor has associated that handle with a resource. The handle can then be used by a software module when the software module desires to perform an operation on the resource. To perform an operation on the resource, the software module makes a request to the access supervisor for a given operation and provides the handle to identify the resource on which the operation is to be performed. The access supervisor then checks to determine whether the handle is valid. If the handle is valid, then the operation may be performed. If the handle is not valid, then an appropriate notification to the software module may be generated.

When a handle is in the unallocated state, it is not associated with any resource and thus cannot be used to access a resource. A handle is in the unallocated state if it is never allocated or when it is “released.” A handle can be released by the software module that allocated it from the access supervisor. Releasing a handle means that the handle is no longer being used to access the resource with which it was formerly associated. Once a handle is released, it is available to be associated with another resource and thereby returned to the allocated state.

However, handles are not always released properly, and the consequences of an improper handle release can be quite costly in terms of correctness, performance, and security. For example, a thread that opens a file may simply fail to close the file, resulting in a handle pointing to the file being leaked. Or, when a thread is terminated, a handle may fail to be released and the corresponding resource, to which the handle refers, may be leaked. Handle leaks like these can compromise program and overall computer performance over time, or simply cause a program to stop working. Furthermore, handle management with semi-trusted code may result in security vulnerabilities in a multithreaded environment.

One method of solving this problem is described in U.S. application Ser. No. 10/853,420, entitled “Safe Handle”, filed May 25, 2004. A handle is wrapped with a wrapper that includes a counter to tabulate the number of threads currently using the handle. The counter may be used to determine whether there are any operations being performed on the handle. The release of the handle may then be prevented while operations are being performed on the handle.

For memory accesses, problems may arise when a write to a memory resource occurs while the memory resource is being freed. This may occur when garbage collection occurs prematurely on a resource and a finalizer releases the memory resource while another thread is attempting a write. In that case, the memory may no longer be valid for a write. It is difficult to write unsafe managed code that can safely use pointers without the risk of accessing freed memory in the process space. Most of the existing solutions are not suitable substitutes for all uses of pointers to memory. Memory can occur in three interesting locations in a runtime environment—an unmanaged heap (ie, what malloc provides), a managed heap (controlled by a GC), and the stack. When not using the unmanaged heap and potentially in uses where you can guarantee the absence of multiple threads, any additional ref counting (as opposed to a simple boolean flag) to track the lifetime of the memory can be an unnecessary performance hit.

Access to pointers can be restricted for various reasons. The first is verifiability—as pointers generally increase risk in your code, some environments may choose not to allow unverifiable code to run. Alternately, a host may provide a trusted library that supports pointers, which then returns safe components to untrusted code. Furthermore, some programming languages such as Visual BASIC do not even support pointers. However, a type that is constructed by trusted code (using pointers) then handed to untrusted code would solve this issue. In some of these cases, the existing solutions may not be appropriate (i.e. access to memory on the stack).

### SUMMARY

In one implementation, various technologies and techniques are disclosed for implementing a safe buffer. In accordance with one implementation of the described technologies, a buffer class is implemented that ensures that accesses to memory are performed in a safe manner. The buffer class may be a handle to protected resources in memory. The buffer class may exploit methods to read and write to memory that ensures that reads and writes are performed to valid memory locations within buffer bounds. These methods may provide protection against incorrect or malicious handle usage from multiple threads.

In another implementation, various technologies and techniques are disclosed for allowing accesses to unmanaged memory. An unmanaged memory application programming interface is provided for allowing accesses to unmanaged memory. The application programming interface has a constructor, dispose method, read method, and write method. The constructor allows an instance of an unmanaged memory object to be created. The dispose method allows the lifetime of the instance of the unmanaged object to be controlled, potentially independently, of the lifetime of the underlying resource. (There are cases where the unmanaged memory class may exceed the lifetime of the underlying resource, or where the underlying resource's lifetime must exceed the lifetime of the unmanaged memory API.) The read method accepts a pointer as a parameter and yields a structure variable as an output parameter containing one or more values that were read. The write method performs a write operation to a specified location. The application programming interface enables random access to previously allocated unmanaged memory in a type-safe and memory-safe way, with the random access being allowed to any location within the unmanaged memory.

In another implementation, a pointer is provided that ensures that accesses to memory are performed in a safe manner, the pointer being used internally by a particular program to manage access to a range of unmanaged memory. An unmanaged memory application programming interface is then provided to allow access to a sub-range of the unmanaged memory by external applications.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an example network environment in which example technologies may be implemented for a safe buffer.

FIG. 2 is a block diagram illustrating an exemplary implemention of a safe buffer.

FIG. 3 is a flow diagram illustrating an exemplary process for implementing a safe buffer.

FIG. 4 is a process flow diagram for one implementation illustrating the stages involved in handling accesses to unmanaged memory.

FIG. 5 is a diagrammatic view of an unmanaged memory API application of one implementation.

FIG. 6 is a process flow diagram for one implementation illustrating the stages involved in safely accessing any location in the unmanaged memory.

FIG. 7 is a logical diagram illustrating some components of an unmanaged memory application programming interface.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

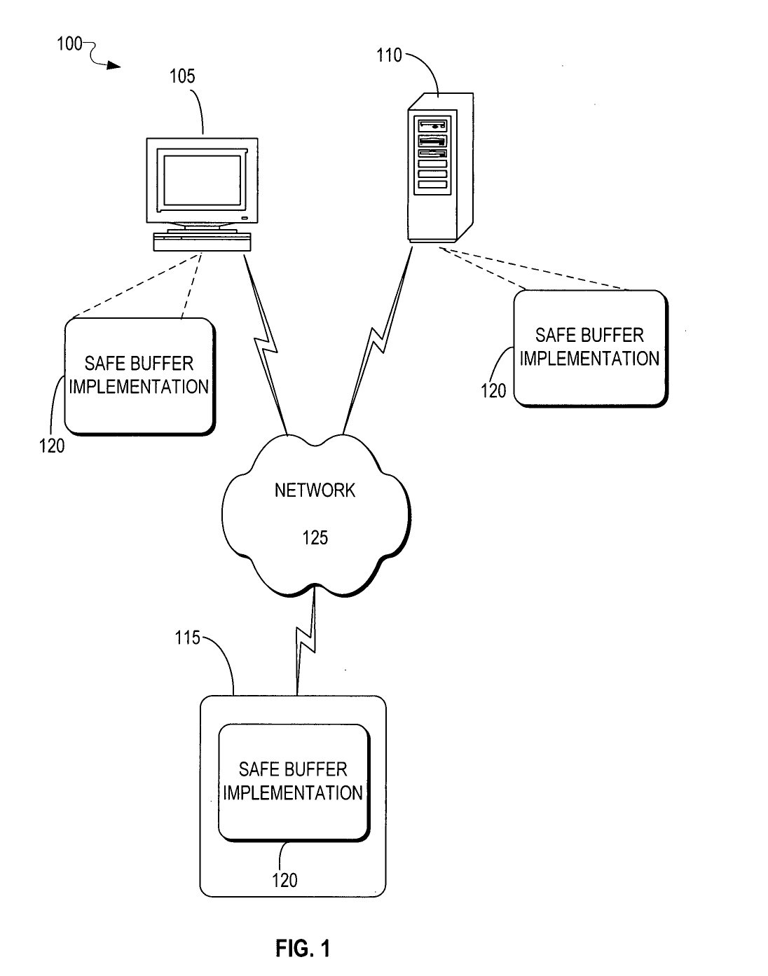

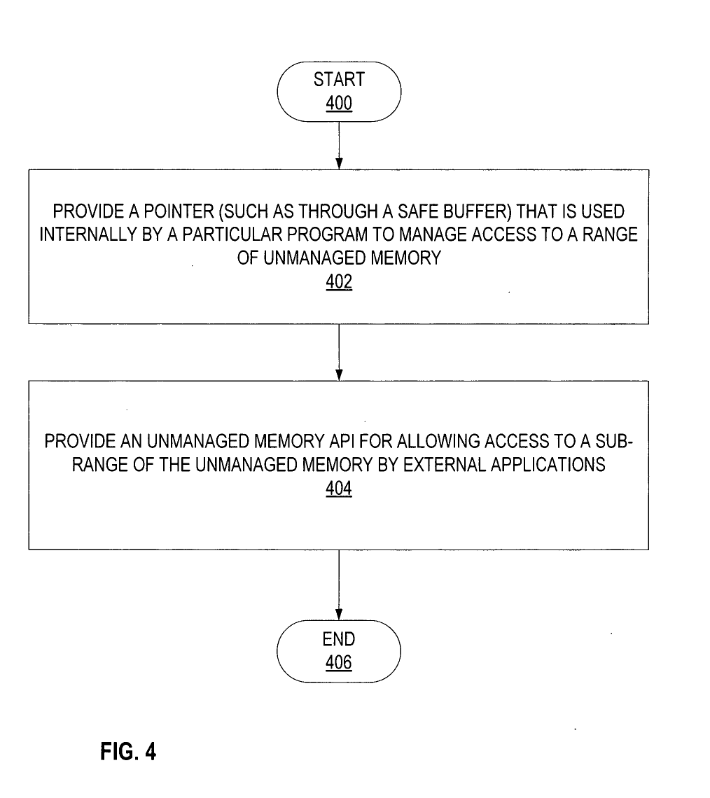

FIGS. 1-3 herein discuss various technologies and techniques for implementing a safe buffer. FIGS. 4-8 discuss various technologies and techniques for implementing an unmanaged memory accessor.

Turning now to FIG. 1, an example network environment 100 is shown in which example technologies may be implemented for a safe buffer. However, such example technologies are not limited to network environments. Such technologies may include, but are not limited to, tools, methodologies, and systems, associated with a safe buffer implementation 120, as described herein. In FIG. 1, client device 105, server device 110, and “other” device 115 may be communicatively coupled to one another via network 125; and, further, at least one of client device 105, server device 110, and “other” device 115 may be capable of implementing the aforementioned technologies.

Client device 105 may represent at least one of a variety of known computing devices, including a desktop personal computer (PC), workstation, mainframe computer, Internet appliance, set-top box, or gaming console, that is able to implement example technologies for a safe buffer. Client device 105 may further represent at least one device that is capable of being associated with network 125 by a wired and/or wireless link, including but not limited to a mobile telephone, personal digital assistant (PDA), and laptop computer. Further still, client device 105 may represent the client devices described above in various quantities and/or combinations thereof. “Other” device 115 may also be embodied by any of the above examples of client device 105.

Server device 110 may represent any device that is capable of providing any of a variety of data and/or functionality to client device 105 or “other” device 115 in accordance with at least one implementation for a safe buffer. The data may be publicly available or alternatively restricted, e.g., restricted to only certain users or only if an appropriate subscription or licensing fee is paid. Server device 110 may be at least one of a network server, an application server, a blade server, or any combination thereof. Typically, server device 110 may represent any device that may be a content source, and client device 105 may represent any device that may receive such content either via network 125 or in an off-line manner. However, according to the example implementations described herein, client device 105 and server device 110 may interchangeably be a sending node or a receiving node in network environment 100. “Other” device 115 may also be embodied by any of the above examples of server device 110.

“Other” device 115 may represent any further device that is capable of a safe buffer implementation 120 according to one or more of the example technologies described herein. These examples are not intended to be limiting in any way, and therefore should not be construed in that manner.

Network 125 may represent any of a variety of conventional network topologies and types, which may include wired and/or wireless networks. Network 125 may further utilize any of a variety of conventional network protocols, including public and/or proprietary protocols. Network 125 may include, for example, the Internet as well at least portions of one or more local area networks (LANs), such as an 802.11 system or, on a larger scale, a wide area network (WAN), or a personal area network (PAN), such as Bluetooth.

Computer architecture in at least one of devices 105, 110, and 115 has typically defined computing platforms in terms of hardware and software. Software for computing devices has been categorized into groups, based on function, which may include: a hardware abstraction layer (HAL), an operating system (OS), and applications.

A runtime execution environment may reside between an OS and an application, program, function, or other assemblage of code. The runtime execution environment may serve as a space in which the application, program, function, or other assemblage of code may execute specific tasks on any one or more of processing devices 105, 110, and 115. More particularly, a runtime execution environment may enhance the reliability of the execution of an application, program, function, or other assemblage of code on a growing range of processing devices 105, 110, and 105, including servers, desktop computers, laptop computers, and mobile processing/communication devices by providing a layer of abstraction and services for an application running on such devices, and by further providing the application, program, function, or other assemblage of code with capabilities including memory management and configuration thereof.

A runtime execution environment may serve as at least one of a programming and an execution platform. As a programming platform, a runtime execution environment may compile one or more targeted applications, programs, functions, or other assemblages of code, which may be written in one of multiple computing languages, into an intermediate language (IL) or byte code. IL is typically independent of the platform, and the central processing unit (CPU) executes IL. In fact, IL is a higher level language than many CPU machine languages.

As an execution platform, a runtime execution environment may interpret compiled IL into native machine instructions. A runtime execution environment may utilize either an interpreter or a compiler to execute such instructions. Regardless, the native machine instructions may then be directly executed by the CPU. Since IL is CPU-independent, IL may execute on any CPU platform as long as the OS running on that CPU platform hosts an appropriate runtime execution environment.

Alternatively, at least portions of applications, programs, functions, or other assemblages of code may be precompiled and loaded as one or more native image files in the runtime execution environment, thus circumventing CPU consumption required for compilation. Effectively, the precompiled portions are software modules that are distributed in an IL format (e.g. assemblies, methods, or types) rather than in a native platform execution format. A source of such precompiled IL may be disposed in either of a non-managed execution environment or a separate implementation of a runtime execution environment on a same or separate one of devices 105, 110, and 1115. The source may deploy the precompiled IL during or before install time for the application, program, method, function, or other assemblage of code to which the precompiled IL corresponds.

Regardless, examples of runtime environments, in which technologies for a safe buffer may be implemented, include: Visual Basic runtime environment; Java Virtual Machine runtime environment that is used to run, e.g., Java routines; or Common Language Runtime (CLR) to compile, e.g., MICROSOFT®.NET applications into machine language before executing a calling routine. However, this listing of runtime environments provides examples only. The example technologies described herein are not limited to just these managed execution environments. More particularly, the example implementations are not just limited to managed execution environments, for one or more examples may be implemented within testing environments and/or unmanaged execution environments.

An application, program, function, or other assemblage of code compiled into IL may be referred to as “managed code,” and that is why a runtime execution environment may be alternatively referred to as a “managed execution environment.” It is noted that code that does not utilize a runtime execution environment to execute may be referred to as a native code application.

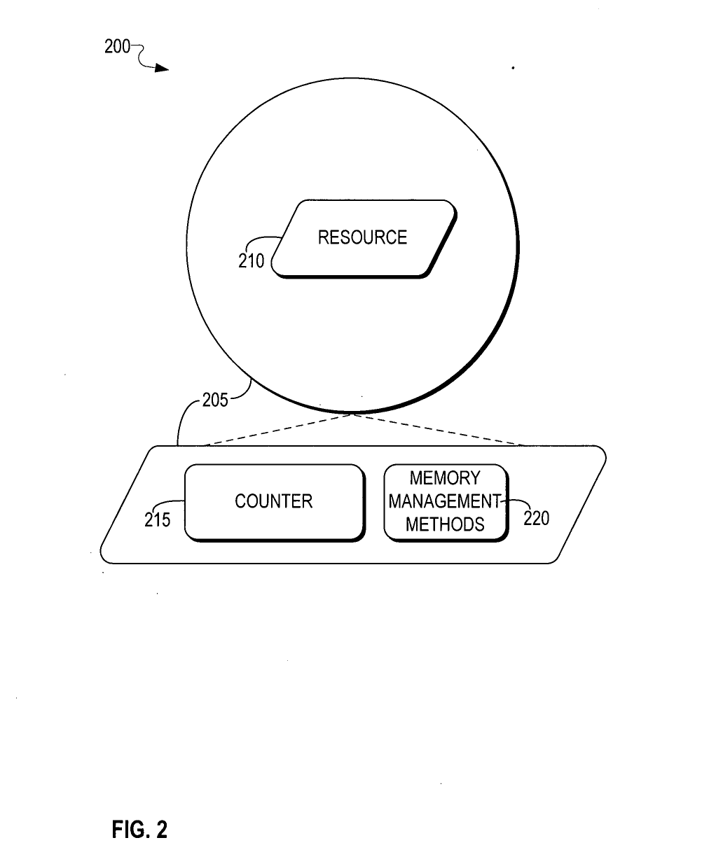

FIG. 2 is a block diagram illustrating an exemplary implementation of a safe buffer 200. The safe buffer 200 includes a wrapper 205 that wraps around a protected memory resource 210. Wrapper 205 is either a data structure or software that contains, or wraps around, protected resource 210. Wrapper 205 includes memory management methods 220. Memory management methods 220 include methods to read and write to memory. Wrapper 205 may also include a counter 215 to determine whether the resource 210 is available to be accessed.

Problems with accessing freed memory may occur when a write to a memory location occurs while the memory location is being freed. For example, a set function may be called to write a character to a memory location while a dispose function is being called to free the memory location. In this case, the write is being attempted at a memory location that may no longer be valid. In the presence of multiple threads, sometimes this memory location may be allocated by another thread, so the attempt to write to this location succeeds, even though the memory is not being used for its original purpose. Tracking down memory corruption in a multithreaded environment is often quite challenging.

In another example, consider the CLR, which enables interaction of managed code with unmanaged code. In this environment, unmanaged code (such as the MICROSOFT® WINDOWS® kernel) typically serves as a handle administrator, and therefore interacts with managed code to utilize resources. More particularly, a handle that is detected by the handle administrator as not being used, even though the handle is tentatively released or otherwise suspended, may be closed, disposed, or subjected to some other finalizing method for the purpose of memory management or resource recycling. For example, in the MICROSOFT®.NET platform, the managed method of “garbage collection” aggressively cleans up unused objects to reclaim memory. However, if garbage collection occurs prematurely on a type containing a handle and that type provides a finalizer that releases a memory source, the resource would be prematurely finalized (or disposed), and another thread could be attempting to write to an invalid memory location.

Garbage collection typically involves both a step to detect unused objects and a second pass called finalization, where some unused objects are given a chance to run their own cleanup code to free another resource. It is possible for malicious code to “resurrect” an object that garbage collection determined was unused, which causes an object that was previously considered “dead” available for future use or coming back to “life.” This “resurrection” may occur concurrently with running a finalizer and can be used to expose an object that is still usable, or one whose finalizer has completed, or one whose finalizer will run while you are manipulating the object. Depending on the type of resurrected object, this may open the door to correctness and/or security problems.

To solve these problems, safe buffer 200 is a handle to a protected memory resource that exploits methods to read and write to memory that ensure that reads and writes are to valid memory locations within buffer bounds.

An exemplary code implementation using the safe buffer class may be as follows:

```
Class SecureString {
SafeBstrBuffer ptr;
int length;
SecureString ( ) {
  ptr=Virtual Alloc ( )
  Ptr.SetLength(length)
}
Void Set (char c, int index){
  ptr.Write (c, index);
}
Void Dispose{
  ptr.Dispose( );
}
}
```

Users may subclass the buffer class to provide an implementation of a safe resource wrapper for a resource. The example above presupposes a subclass of a safe buffer class, specialized for a particular string representation called a BSTR. The buffer class includes a length, which may be used to ensure that accesses do not exceed the length of the buffer. The Set function calls Write( ) to write the character to the proper memory location. The Dispose function may call a Virtual Free function to free the memory location if the memory location is not currently being accessed. The reference counter 215 may be used to determine whether to allow access to the memory resource and to ensure that the protected memory resource is not freed as it is being accessed. While the reference counter 215 is typically used within the safe buffer's memory management methods 220, it may optionally be made available to users directly to allow multiple accesses to memory to amortize the overhead of using the reference counter 215.

By implementing a safe resource wrapper for a memory resource, reads and writes to the memory resource may be performed in a safe manner. The safe buffer class may also serve as a building block for static analysis and verification.

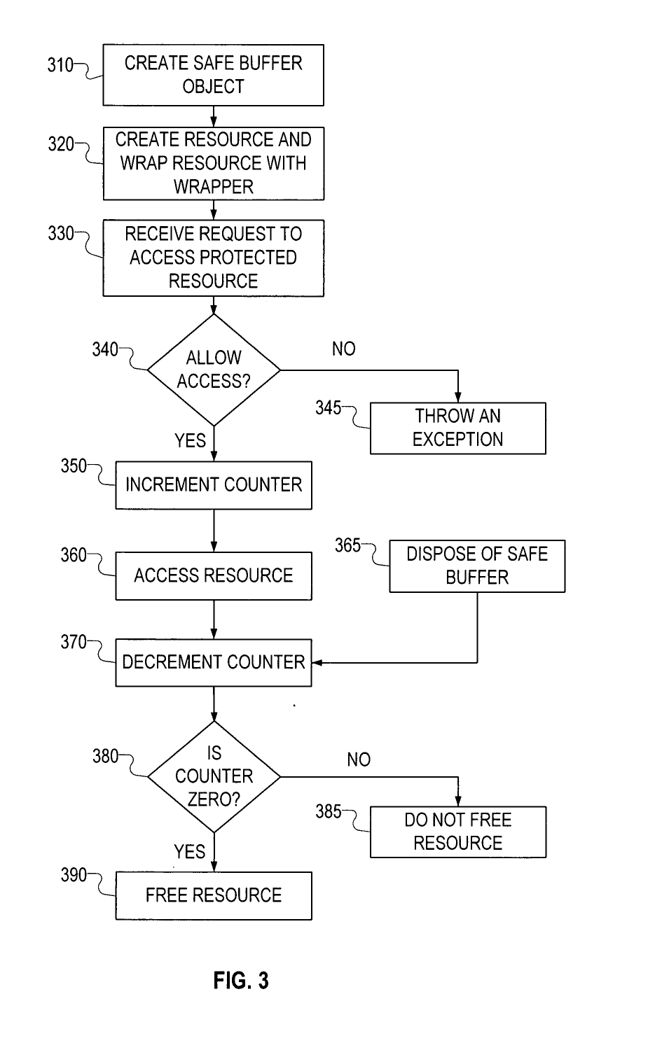

FIG. 3 is a flow diagram illustrating an exemplary process for implementing a safe buffer. While the description of FIG. 3 may be made with reference to other figures, it should be understood that the exemplary process illustrated in FIG. 3 is not intended to be limited to being associated with the systems or other contents of any specific figure or figures. Additionally, it should be understood that while the exemplary process of FIG. 3 indicates a particular order of operation execution, in one or more alternative implementations, the operations may be ordered differently. Furthermore, some of the steps and data illustrated in the exemplary process of FIG. 3 may not be necessary and may be omitted in some implementations. Finally, while the exemplary process of FIG. 3 contains multiple discrete steps, it should be recognized that in some environments some of these operations may be combined and executed at the same time.

At 310, a safe buffer object is created. For example, a runtime environment may recognize the need to create an instance of a subclass of a safe buffer. A safe buffer may be created for a runtime agent requiring a handle to access a resource upon which an operation is to be performed. Some runtime agents may create the safe buffer object before creating the underlying resource. At 320, a resource is created and a wrapper is wrapped around the resource. The wrapper may include memory management methods to ensure that accesses to memory are performed in a safe manner. The wrapper may include a counter that is set to one upon creation of the safe buffer object and decremented when the safe buffer object is disposed, such as through a finalizer or a dispose method.

At 330, a request is received to access the memory resource. At 340, a determination is made as to whether to allow access to the resource based at least in part on the value of the counter. For example, if the value of the counter is zero, this may indicate that the resource has been freed, so at 345, access may be denied. Access may be denied by throwing an exception, reporting an error, or via various other methods. Additionally, if the length of the safe buffer is tracked, then invalid accesses that exceed the length of the buffer may also be denied at 340.

If the value of the counter is greater than zero, then this may indicate that the resource may be safely accessed, so access may be allowed. At 350, the value of the counter is incremented, indicating that a thread is actively using the safe buffer's resource. Then, at 360, the resource may be accessed. After accessing the resource, at 370, the counter is decremented to indicate that one less thread is using the safe buffer. Separately, at 365, when the safe buffer is disposed, such as through a finalizer or a dispose method, then the counter is also decremented at 370.

At 380, the value of counter is checked to determine if it is zero. If the counter is nonzero, this may indicate that one or more threads are still using the safe buffer, so at 385, the resource is not freed. If the counter is zero, then this may indicate that no threads are currently using the safe buffer, and the safe buffer has been disposed, so the resource is freed at 390. By ensuring the resource is only freed when no other threads are using it in a thread-safe fashion, corruption problems due to malicious abuse of the resource, resurrection, or imperfect programming practices are prevented.

The above is one example of a process for implementing a safe buffer. It is understood that in other implementations, various other steps and runtime checks may be implemented to ensure safe accesses to memory.

For instance, in one alternative, the counter may represent the number of threads accessing the resource. When the counter is zero, this may indicate that no threads are accessing the resource. Therefore, access to the resource may be allowed. If the counter is nonzero, this may indicate that one or more threads are accessing the resource and the current request for access to the resource may be denied or postponed until another thread decrements the counter to zero. The decision to release the resource may be made based on the value of the counter and either additional state in the object or the lifetime of the safe buffer object. Various other implementations may also be used.

Turning now to FIGS. 4-7, various technologies and techniques for implementing an unmanaged memory accessor are described. FIG. 4 illustrates one implementation of the stages involved in handling accesses to unmanaged memory. In one form, the process of FIG. 4 is at least partially implemented in the operating logic of a computing device with a similar configuration as described for client computing device 105. While the description of FIG. 4 may be made with reference to other figures, it should be understood that the exemplary process illustrated in FIG. 4 is not intended to be limited to being associated with the systems or other contents of any specific figure or figures. Additionally, it should be understood that while the exemplary process of FIG. 4 indicates a particular order of operation execution, in one or more alternative implementations, the operations may be ordered differently. Furthermore, some of the steps and data illustrated in the exemplary process of FIG. 4 may not be necessary and may be omitted in some implementations. Finally, while the exemplary process of FIG. 4 contains multiple discrete steps, it should be recognized that in some environments some of these operations may be combined and executed at the same time.

The process begins at start point 400 with the system providing a pointer that is used internally by a particular program, such as a framework runtime, to manage access to a range of unmanaged memory (stage 402). In one implementation, the pointer is provided using a safe buffer as described in FIGS. 1-3 herein (stage 402). The system provides an unmanaged memory application programming interface (API) for allowing access to a sub-range of the unmanaged memory by external applications (stage 404). In one implementation, the API allows random access to any location in the sub-range in a type-safe and memory-safe safe way, even from environments or languages that do not allow pointers (stage 404). The process ends at end point 406.

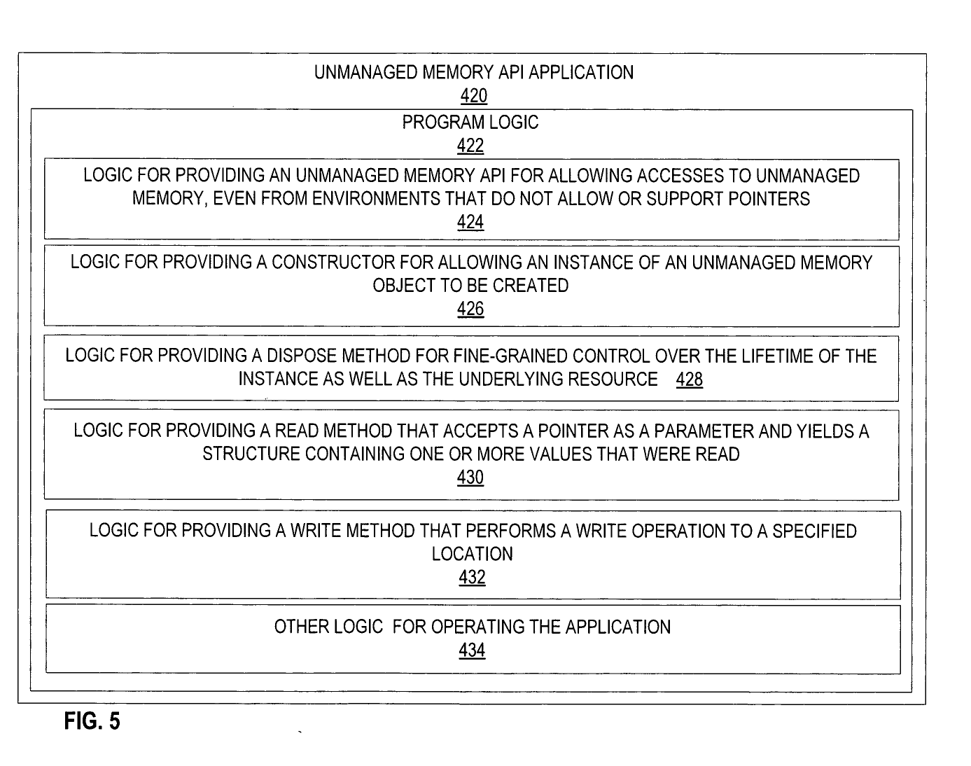

Turning now to FIG. 5, an unmanaged memory API application 420 operating on a computing device such as client computing device 105 is illustrated. However, it will be understood that unmanaged memory API application 420 can alternatively or additionally be embodied as computer-executable instructions on one or more computers and/or in different variations than described herein. Alternatively or additionally, one or more parts of unmanaged memory API application 420 can be part of system memory, on other computers and/or applications 115, or other such variations as would occur to one in the computer software art.

Unmanaged memory API application 420 includes program logic 422, which is responsible for carrying out some or all of the techniques described herein. Program logic 422 includes logic for providing an unmanaged memory API for allowing accesses to unmanaged memory, even from environments that do not support pointers 424; logic for providing a constructor for allowing an instance of an unmanaged memory object to be created 426; logic for providing a dispose method for fine-grained control over the lifetime of the instance as well as the underlying resource 428; logic for providing a read method that accepts a pointer as a parameter and yields a structure containing one or more values that were read 430; logic for providing a write method that performs a write operation to a specified location; and other logic for operating the application 434. In one implementation, program logic 422 is operable to be called programmatically from another program, such as using a single call to a procedure in program logic 424.

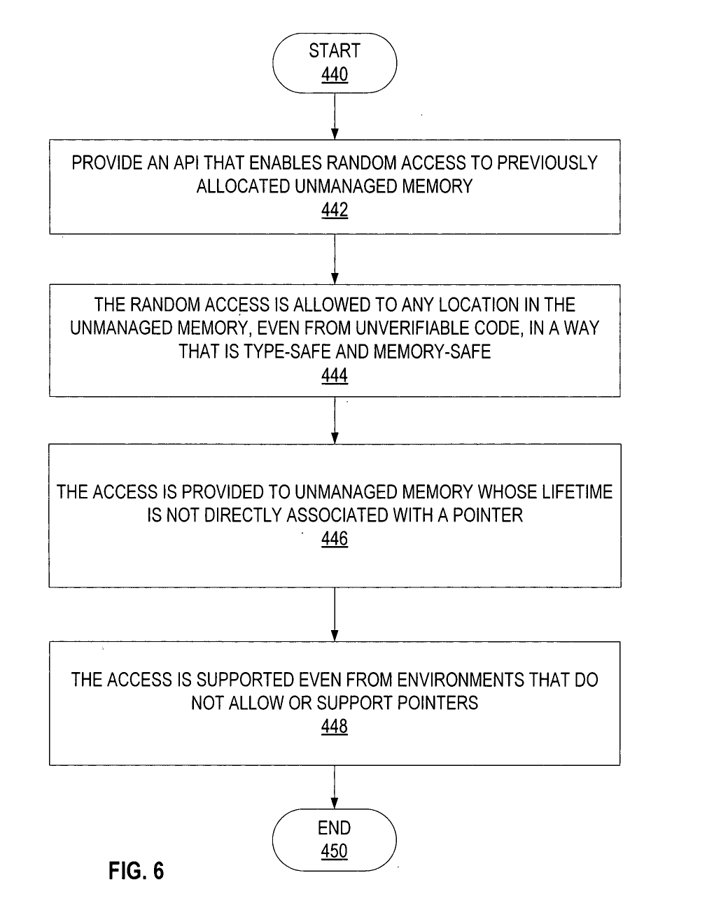

FIG. 6 illustrates one implementation of the stages involved in safely accessing any location in the unmanaged memory. In one form, the process of FIG. 6 is at least partially implemented in the operating logic of a computing device with a similar configuration as described for client computing device 105. While the description of FIG. 6 may be made with reference to other figures, it should be understood that the exemplary process illustrated in FIG. 6 is not intended to be limited to being associated with the systems or other contents of any specific figure or figures. Additionally, it should be understood that while the exemplary process of FIG. 6 indicates a particular order of operation execution, in one or more alternative implementations, the operations may be ordered differently. Furthermore, some of the steps and data illustrated in the exemplary process of FIG. 6 may not be necessary and may be omitted in some implementations. Finally, while the exemplary process of FIG. 6 contains multiple discrete steps, it should be recognized that in some environments some of these operations may be combined and executed at the same time.

The process begins at start point 440 with the system providing an application programming interface that enables random access to previously allocated unmanaged memory (stage 442). In one implementation, the API allows access to memory on the managed heap, native heap, and/or the stack. The random access is allowed to any location in the unmanaged memory, even from unverifiable code, in a way that is type-safe and memory-safe (stage 444). The access is provided to unmanaged memory whose lifetime is not associated with a pointer (stage 446). The access is supported even from environments that do not support pointers (stage 448), such as Visual Basic. The process ends at end point 450.

Unverifiable code is often riskier code, so reducing total amount of unverifiable code can reduce some of the risks of a security hole. In one implementation, the unmanaged memory API helps reduce some of these security risks by allowing the accesses to memory from unverifiable code to be performed safely through the API, as noted in stage 442. In one implementation, the access from unverifiable code is only allowed with careful restrictions, such as from a trusted library.

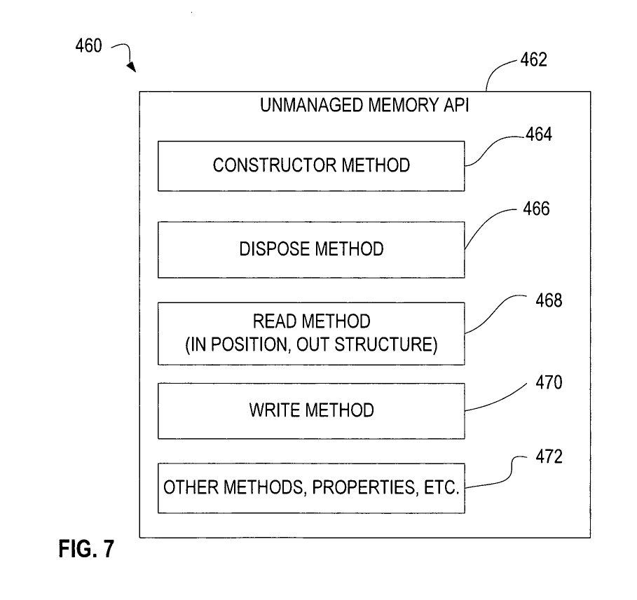

FIG. 7 is a logical diagram 460 illustrating some components of an unmanaged memory application programming interface. Unmanaged memory API 462 includes a constructor method 464, dispose method 466, read method 468, write method 470, and/or other methods, properties, etc. 472. The constructor method 464 is responsible for allowing an instance of an unmanaged memory object to be created. The dispose method 466 is responsible for allowing the lifetime of the unmanaged memory object to be controlled, as well as the lifetime of the underlying resource. The read method 468 is responsible for accepting a pointer as a parameter and yielding a structure containing one or more values that were read. The write method 470 is responsible for performing a write operation to a specified location. There may be other method, properties, etc. 472 supported by the API.

In one implementation, since the lifetime of an unmanaged memory accessor may be separate from the lifetime of the underlying resource, a mechanism is provided to cause all future uses of the unmanaged memory accessor to throw an exception. Disposing of the unmanaged memory accessor will usually free the underlying resource. However, you might want the lifetime of the resource to either exceed the lifetime of the unmanaged memory accessor, such as if you're working with a sub-range within another buffer, and you've got some external lifetime management. Additionally, you may be forced into the possibility of the lifetime of the unmanaged memory accessor exceeding the lifetime of the underlying resource. This could occur if you have a buffer on the stack with an unmanaged memory accessor pointing to it, and your method with the stack space is exiting. In this case, it would make sense to call Dispose 466 on the unmanaged memory accessor to ensure it can't be used, in the event that an alias to it has been stashed away by some code that you called.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A method for handling accesses to unmanaged memory comprising the steps of:
providing a pointer that ensures that accesses to memory are performed in a safe manner, the pointer being used internally by a particular program to manage access to a range of unmanaged memory; and
providing an unmanaged memory application programming interface for allowing access to a sub-range of the unmanaged memory by external applications.

2. The method of claim 1, wherein the particular program that uses the pointer internally is a framework runtime.

3. The method of claim 1, wherein the pointer is provided through use of a safe buffer.

4. The method of claim 1, wherein the application programming interface allows access whose lifetime is not directly associated with a pointer.

5. The method of claim 1, wherein the application programming interface allows accesses to unmanaged memory to be made even from environments that do not allow or support pointers.

6. The method of claim 1, wherein the application programming interface allows type-safe access to the sub-range of the unmanaged memory.

7. The method of claim 1, wherein the application programming interface allows memory-safe access to the sub-range of the unmanaged memory.

8. The method of claim 1, wherein the application programming interface allows random access to any location within the sub-range of the unmanaged memory.

9. The method of claim 8, wherein the read method yields a structure variable as an output parameter.

10. The method of claim 1, the application programming interface allows unverifiable code access to memory.

11. A computer-readable medium having computer-executable instructions for causing a computer to perform the steps recited in claim 1.

12. A computer-readable medium having computer-executable instructions for causing a computer to perform steps comprising:
provide an unmanaged memory application programming interface for allowing accesses to unmanaged memory, the application programming interface comprising:
a constructor for allowing an instance of an unmanaged memory object to be created;
a dispose method for fine-grained control between a lifetime of the instance and a lifetime of an underlying resource; and
a write method that performs a write operation to a specified location.

13. The computer-readable medium of claim 12, wherein the read method has a position variable as an input parameter.

14. The computer-readable medium of claim 13, wherein the position variable indicates a location of memory from which to read.

15. The computer-readable medium of claim 12, wherein the read method has a structure variable as an output parameter.

16. The computer-readable medium of claim 12, wherein the application programming interface allows accesses to unmanaged memory to be made even from environments that do not allow or support pointers.

17. A method for safely accessing memory from any location comprising the steps of:
providing an application programming interface that enables random access to previously allocated unmanaged memory in a type-safe and memory-safe way, the random access being allowed to any location within the unmanaged memory.

18. The method of claim 17, wherein the application programming interface enables access to unmanaged memory whose lifetime is not associated with a pointer.

19. The method of claim 17, wherein the application programming interface allows accesses to unmanaged memory to be made even from environments that do not allow or support pointers.

20. A computer-readable medium having computer-executable instructions for causing a computer to perform the steps recited in claim 17.
